(19) United States
(12) Patent Application Publication
(10) Pub. No.: US 2019/0325506 A1
(43) Pub. Date: Oct. 24, 2019

(54) SYSTEM AND METHOD FOR PROVIDING AD-HOC DEMONSTRATION OF ITEMS AVAILABLE FOR PURCHASE FROM ONLINE VENDORS

(71) Applicant: Northeast Relocation Inc., Stoneham, MA (US)

(72) Inventor: Patrick Flynn, Reading, MA (US)

(21) Appl. No.: 16/392,229

(22) Filed: Apr. 23, 2019

Related U.S. Application Data
(60) Provisional application No. 62/661,313, filed on Apr. 23, 2018.

(51) Int. Cl. G06Q 30/06; G06F 3/0482

(52) U.S. Cl. CPC G06Q 30/0641; G06Q 30/0645; G06F 3/0482; G06Q 30/0613

(57) ABSTRACT

A method and apparatus facilitate electronic commerce by allowing items in use at the user's location to act as physical representations of items available for purchase electronically. Thus, the user's location becomes, in effect, a showroom for items available for purchase online for which corresponding physical representations exist and are in use at the user's location.

### CROSS-REFERENCE TO RELATED APPLICATION(S)

This application claims priority to, and the benefit of, U.S. Provisional Application 62/661,313 filed Apr. 23, 2018. The disclosure of said application is hereby incorporated by reference in its entirety.

### FIELD OF THE INVENTION

The present invention relates to a system and method that combines using a plurality of physical items for their intended use in a rented space, and facilitating the purchase of the same or similar items electronically from third party vendors.

### BACKGROUND

The use of electronic or online commerce by consumers for the purchase of goods has been increasing leading to the decline in purchases in traditional physical retail stores. Electronic commerce provides a level of convenience and variety that is difficult for traditional physical retail stores to match.

However, this electronic or online commerce experiences some shortcomings. For example, although most electronic commerce sites provide pictures and descriptions, it is still difficult for a consumer to evaluate the goods for sale as there are no physical examples or samples readily available for inspection. Even with pictures and description, it can be difficult to determine size, color, texture, or quality of items for sale without being able to interact with the item in the physical world. To overcome this issue, many consumers visit so called brick and mortar stores that exist in the physical world and stock the actual physical items the consumer is interested in purchasing. Then, having interacted and evaluated the desired item in the physical world, the consumer then purchases the item online using electronic commerce sites. This presents a problem for the so called “brick and mortar” stores, for without the revenue from the sale of the items, the “brick and mortar” store cannot afford to allocate commercial space to stock and display the item, as well as cover the monetary cost of potential theft or damage of displayed items. Thus, with the sale of the items going to online vendors, it becomes financially difficult for the brick and mortar store to provide a physical sample for evaluation where a consumer can see, touch, and otherwise interact with the item. In addition, even in physical store locations, the goods are most often provided still encompassed within packaging, which prevents access to and interaction with the goods in a real life use-based setting.

### SUMMARY

There is a need for addressing the lack of physical samples for items offered for sale online through electronic commerce sites, and for the inability of a customer to experience real time use of the products prior to deciding whether to purchase said products. The present invention is directed toward further solutions to address this need, in addition to having other desirable characteristics. Specifically, providing a tangible item in a real-time, interactive, physical, in-use setting, for which a different instance of the same or similar item (but not the actual physical instance being interacted with by the customer) is made available for purchase electronically so that a consumer can interact with the item before making a purchasing decision, while at the same time minimizing the costs associated with providing a physical representation of said item or items.

The methods and apparatus of the present invention enable the items in use at the user's location to act as physical representations of items available for purchase electronically. Thus, the user's location becomes, in effect, a showroom for items available for purchase online for which corresponding physical representations exist and are in use at the user's location.

In many cases, the items at a user's location are already in use providing for the functionality of the location, thus the cost for providing them is already justified. An example of this is in the hospitality industry.

Hotels, inns, bed and breakfasts, and other lodgings, as well as long and short term rental properties are all typically provided pre-furnished with amenities to make a user's stay more comfortable or convenient. The cost for furnishing the space is already a sunk cost, which provides an opportunity for the amenities of the location to provide a secondary function as a physical representation of the same or similar items available for purchase electronically. Furthermore, if the items in use at the location acting as physical representation for items available for purchase electronically incentivize the actual purchase of the item, the electronic vendor may be willing to purchase, reimburse, subsidize, or otherwise offset the cost of furnishing the items in use at the location. Similarly, because of the locational awareness of the present invention, is also possible for the owner or proprietor of the location to be compensated by the electronics vendor for use of the location as a “show room.”

Furthermore, the location of hotels or other lodgings are fairly well-established, and the amenities provided have been cataloged for insurance and loss prevention purposes, thus reducing the logistical and technological issues of identifying the existing items in use at the location.

In accordance with example embodiments of the present invention, a method for purchasing items for which representative physical items are in use at a user location is provided. The method includes a number of steps performed on an electronic device. The method includes providing, on an electronic device using a processor, a collection identifying one or more items existing at the user location that serve as representative physical items in use for one or more items available for purchase; displaying, on the electronic device using the graphical user interface, one or more items available for purchase for which a representative physical item in use exists at the user location; receiving, using a user interface of the electronic device, a user item selection by the user of the one or more items available for sale for which a representative physical item in use exists at the user location; displaying, on the electronic device using the graphical user interface, one or more purchasing options from one or more third party vendors for the one or more items selected by the user; receiving, using a user interface of the electronic device, a selection of one or more purchasing options from a user; and transferring, from the electronic device using the processor and an electronic network, the user item selection to the one or more third party vendors providing the one or more purchasing options selected by the user to complete a purchase transaction for the one or more items selected by the user.

In accordance with aspects of the present invention, the method can further comprise providing an electronic device, the electronic device comprising; a memory for storing data including a collection identifying one or more items existing at the user location that serve as representative physical items in use for one or more items available for purchase; and an electronic display comprising a graphical user interface for displaying data.

In accordance with aspects of the present invention, the user location can comprise a rental property.

In accordance with aspects of the present invention, the one or more third party vendors can comprise a local vendor, and the one or more items for purchase can comprise a domestically manufactured product.

In accordance with aspects of the present invention, the method can further comprise determining, on the electronic device, the location of a user, wherein providing a collection identifying one or more items existing at the user location that serve as representative physical items in use for one or more items available for purchase comprises obtaining the collection from a server.

In accordance with aspects of the present invention, the selection of an item available for purchase can be made via a provided optical input device or sensor, and displaying, on the electronic device using the graphical user interface, one or more purchasing options from one or more third party vendors for the one or more items selected by the user can further comprise: receiving, using a provided optical input device or sensor, a processor comprising an image recognition tool, item data that includes comprising one or more images for each of one or more items; capturing and extracting embedded data within the one or more images or the one or more items through using the image recognition tool; comparing the list of identity attribute data to the collection identifying one or more items existing at the user location previously received from participating third party vendors and stored in a data store; mapping, using an algorithm comprising matching rules and the processor, the item selection by the user to the one or more items available for sale saved in the data store as part of the collection identifying one or more items existing at the user location and the one or more third party vendors corresponding to the one or more items available that were mapped, based on compared identity attribute data from the list of identity attribute data and stored attributes of the collection identifying one or more items existing at the user location; and recording in the data store, and providing to the electronic device for display on the graphical user interface, product data comprising the one or more items available for sale mapped to the user item selection by the user and navigation data for one or more purchasing options comprising one or more links.

In accordance with aspects of the present invention, one or more items existing at the user location that serve as representative physical items can be subsidized, at least in part, by the one or more third party vendors offering the item for purchase, wherein the proprietor of the user location is compensated for use of the location in the purchase transaction of the one or more items for hosting the one or more items existing at the location that serve as representative physical items in use for one or more items available for purchase.

In accordance with aspects of the present invention, the transferring, from the electronic device, the user item selection to the one or more third party vendors providing the one or more purchasing options selected by the user to complete a purchase transaction for the one or more items selected by the user can further comprise transferring user purchasing data along with the selection to one or more websites or web portals provided by the one or more third party vendors. The data store can comprises a database accessible to the electronic device. The product data can further comprise item attribute data, and the one or more third party vendors providing the one or more purchasing options corresponding to the one or more items available for sale identified, and the navigation data for the one or more purchasing options can further comprise one or more links comprising an universal resource locator (URL) or web address of the one or more third party vendors identified by the electronic device to be used to complete a purchase transaction.

In accordance with example embodiments of the present invention, an electronic device is provided for facilitating purchasing items for which representative physical items are in use at a user location. The device includes a memory for storing data and instructions for execution and a processor. The processor is configured to provide a collection identifying one or more items existing at the user location that serve as representative physical items in use for one or more items available for purchase; display one or more items available for purchase for which a representative physical item in use exists at the user location; receive a user item selection by the user of the one or more items available for sale for which a representative physical item in use exists at the user location; display one or more purchasing options from one or more third party vendors for the one or more items selected by the user; receive a selection of one or more purchasing options from a user; transfer the user item selection to the one or more third party vendors providing the one or more purchasing options selected by the user to complete a purchase transaction for the one or more items selected by the user. The electronic device includes an electronic display comprising a graphical user interface for displaying data on the electronic device.

In accordance with aspects of the present invention, the electronic device configured to display one or more purchasing options from one or more third party vendors for the one or more items selected by the user can further comprise: receiving, using a provided optical input device or sensor, a processor comprising an image recognition tool, item data that includes comprising one or more images for each of one or more items; capturing and extracting embedded data within the one or more images or the one or more items through using the image recognition tool; comparing the list of identity attribute data to the collection identifying one or more items existing at the user location previously received from participating third party vendors and stored in a data store; mapping, using an algorithm comprising matching rules and the processor, the item selection by the user to the one or more items available for sale saved in the data store as part of the collection identifying one or more items existing at the user location and the one or more third party vendors corresponding to the one or more items available that were mapped, based on compared identity attribute data from the list of identity attribute data and stored attributes of the collection identifying one or more items existing at the user location; and recording in the data store, and providing to the electronic device for display on the graphical user interface, product data comprising the one or more items available for sale mapped to the user item selection by the user and navigation data for one or more purchasing options comprising one or more links.

In accordance with aspects of the present invention, the electronic device can comprise a personal electronic device, and the user location can comprise a rental property.

In accordance with aspects of the present invention, the one or more third party vendors can comprise a local vendor, and the one or more items for purchase can comprise a domestically manufactured product.

In accordance with aspects of the present invention, the processor can be further configured to determine the location of a user, wherein the provided collection identifying one or more items existing at the user location that serve as representative physical items in use for one or more items available for purchase can be obtained from a server.

In accordance with aspects of the present invention, the electronic device can further comprise an optical device wherein the selection of an item available for purchase is made using the optical input device.

In accordance with aspects of the present invention, one or more items existing at the user location that serve as representative physical items can be subsidized, at least in part, by the one or more third party vendors offering the item for purchase, wherein the proprietor of the user location can be compensated for use of the location in the purchase transaction of the one or more items for hosting the one or more items existing at the location that serve as representative physical items in use for one or more items available for purchase.

In accordance with aspects of the present invention, the transfer of the user item selection to the one or more third party vendors providing the one or more purchasing options selected by the user to complete a purchase transaction for the one or more items selected by the user can further comprise transferring user purchasing data along with the selection. The data store can further comprise a database accessible to the electronic device. The product data can further comprises item attribute data, and the one or more third party vendors providing the one or more purchasing options corresponding to the one or more items available for sale identified, and the navigation data for the one or more purchasing options can further comprise one or more links comprising an universal resource locator (URL) or web address of the one or more third party vendors identified by the electronic device to be used to complete a purchase transaction.

### BRIEF DESCRIPTION OF THE FIGURES

These and other characteristics of the present invention will be more fully understood by reference to the following detailed description in conjunction with the attached drawings, in which:

FIG. 1 is a block diagram depicting a network environment in for conducting electronic commerce in accordance with certain embodiments;

FIG. 2 is a block diagram of an electronic device used to facilitate purchasing items for which a physical representation exists and is in use at the user's location in accordance with certain embodiments;

FIG. 3 is a flow diagram depicting a methodology for purchasing items for which a physical representation exists and is in use at the user's location in accordance with certain embodiments;

FIG. 4 is a diagrammatic illustration of a physical location containing items for purchase;

FIG. 5 is an example screen shot depicting items for purchase for which a physical representation exists and is in use at the user's location in accordance with certain embodiments;

FIG. 6 is a an example screen shot in which a user select an item for purchase using the camera of the electronic device in accordance with certain embodiments;

FIG. 7 is an example screen shot providing purchasing options for a selected item in accordance with certain embodiments; and

FIG. 8 is an example screen shot indicating the completion of transaction to purchase and item in accordance with one embodiment.

### DETAILED DESCRIPTION

An illustrative embodiment of the present invention relates to a system and method that allow the physical items in use at the user's location to take on a second functionality by acting as physical representations or instances of items for which the same or similar duplicate items are made available for purchase electronically. Specifically, the system and method of the present invention provide a tangible item in a real-time, interactive, physical, in-use conventional setting, for which a different instance of the same or similar item (but not the actual physical instance being interacted with by the customer) is made available for purchase electronically so that a consumer can interact with the item before making a purchasing decision. Thus, the user's location becomes, in effect, a showroom for items available for purchase online for which corresponding physical representations exist and are in use at the user's location, all while enabling the prospective customer to have full use and interaction with said items in their intended use environment.

An illustrative embodiment of the present invention relates to a specific system and method with means that improves the existing technology by reciting specific structures, functions and steps that accomplish the desired result through an inventive arrangement of components that capture representative physical items in use, and data thereof, representing one or more of said items available for purchase using electronic devices and a vendor recorded in the system, thereby eliminating the need for product interaction in physical vendor retail spaces and the need for manual internet browsing or searches for particular items of interest for purchase. The invention system and method are directed to a particular manner of improving presentation of information in electronic devices, e.g. displays for purchasing items based on interacting with representative physical embodiments of said items that are in use at a user location by transforming captured image data of the representative physical item at the location and otherwise unassociated electronic media of third party vendors providing the items available for purchase into a display of combined data based on matching physical item image attributes and vendor item data, and providing a user selectable options to complete a purchase transaction for the one or more items selected by the user through online commerce activity. In particular, data is aggregated from different sources (e.g., cameras or sensors supplying data to the electronic device) or obtained by one or more instances of software deployed on one or more client devices, then the data is analyzed to determine item types, item attributes or characteristics, positioning and availability, and otherwise identify which items are desired to be purchased by matching elements of those items with existing data sets stored in a data store such as a database. A set of identification rules dictating and instantiating identification actions is implemented to transform the relevant data into identified data supplied with additional information from the existing data sets, including a unique identifier (e.g. UPC or SIU or bar code) that is transmitted with each record for an item to the electronic device. The data may be merged with other data sets that have been identified for the item, such as data regarding a vendor (e.g. supplier, manufacturer or retailer) of the item and website or portal links to pages where the item can be purchased (stored e.g. in a data store including a database), that uses a combined order of specific incorporated rules and functions, not mere use of the computer and existing data processing technology, thereby improving the existing data management technological processes that renders item information into a specific format that is then used and applied to create desired results of data sets, that can be used together in an interactive environment to complete an online purchase for a physical object identified by the electronic device.

The invention's system and process uses the transformed data to improve graphical user interfaces (GUIs) presenting augmented item data, vendor data for the one or more of said items available for purchase, and decision or selection data to a user. The invention creates an interactive display combining elements that could not be reasonably displayed together prior to the existence of the present claimed invention (e.g. users could not readily identify physical items in their immediate surroundings and use content then extracted from those items or images thereof to identify items available for purchase, vendors selling the specific item, and online websites or destinations capable of completing a purchase transaction for the specific item). The system and method integrate the representative physical item data and vendor item data into a practical application in the form of both transformation of data (combining the different data into a selectable data set) and also presentation of the transformed data (combined from both sources) to improve graphical user interfaces (GUIs) presenting verified information regarding items to a user on an electronic device or display device at a user location, which was not possible before. This represents an additional improvement in the technology where prior items and data sets could not be continually evaluated for purchase by comparison between the physical item and online or other data sets about the item to track interaction with the physical environment and translate the interaction into an online purchase.

In accordance with aspects of the present invention, sensors and computing hardware devices of the present invention perform multiple transformation steps necessarily tied to the computing hardware devices. Image capture for image recognition by sensors, including cameras or imaging sensors of the electronic device, captures representative physical items in the location and environment of the user. This represents a practical application of a centralized product or item identification and selection platform that enables databases or data structures storing item data sets, operated by separate, potentially unrelated entities, to transfer and incorporate (including by merging) data sets while the parties are using the system on various electronic devices, including the use of related data in one or more separate databases or data structures that ordinarily would not be capable of interacting due to the above discussed restrictions on combining such data with physical objects for tangible interaction and the existing technological requirements associated with online browsing and search. In-person data is critical to properly understanding the effectiveness or safety of an item when applied to the actual environment with the user, for example whether the item will fit properly with the physical characteristics of the user or will meet a requirement specific to the user, including aesthetic and other intangible requirements that are difficult or impossible to determine in a virtual online environment. Additionally, the transformation steps performed in the present invention are designed to provide an improvement necessitated by changes in technology and that the present invention solves the problem created by these changes in technology. For example, the present invention determines item identity from image recognition of captured physical item images, augmenting the identified items associated with the item records corresponding to the item for purchase electronically via website, online catalog, web portal, etc. This functionality provides many added benefits not previously available to consumers, by automatically moving the representative physical item and the vendor item data to a shared position on the GUI that augments the shared positions of the combined data with data for making selections of options for purchasing the item. This transformed data functions differently than, and achieves benefits over, conventional database structures and data therein, providing increased flexibility, and the ability to combine otherwise un-combinable data sets. This in turn enables databases or data structures containing item data sets, operated by separate, potentially unrelated entities, to query, receive, and incorporate (including by merging) data sets for selection of products in a separate database or data structure that ordinarily would not be capable of interacting due to the above discussed restrictions on combining such data and the existing technological requirements of reproducing data within data structures in order to preserve unique identifiers and data used to accurately correlate or match data based on association with an underlying item, entity or environment. As would be appreciated by one skilled in the art, the item data sets are not limited to items on file but can also be extended to items e.g. associated with other comparable or related items without departing from the scope of the present invention. The identification of item data sets for online purchase and data sets provided by the present invention enables item indicators or data to be merge-able with vendor (e.g. retailer) data sets in such a way that data sets from disparate sources but relating to a same item can be matched up and associated with each other.

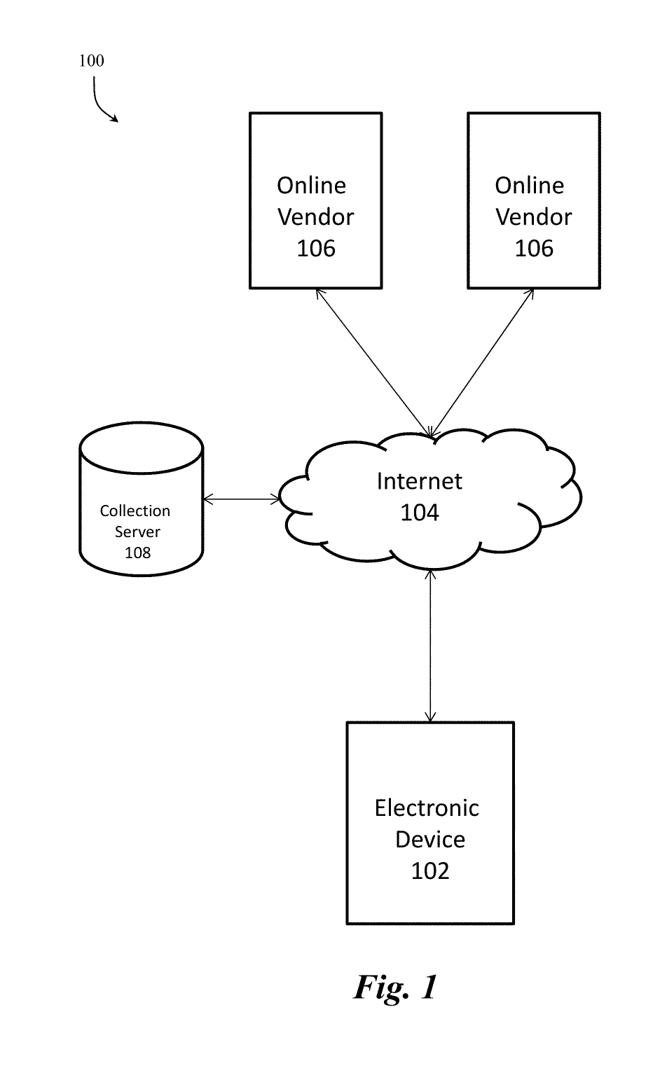

FIG. 1 through FIG. 8, wherein like parts are designated by like reference numerals throughout, illustrate an example embodiment or embodiments of method and devices for purchasing items for which representative physical items are in use at a user location, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an example network environment 100 in which the electronic commerce of the present invention is performed. Here, an electronic device 102 is connected to the internet 104 to provide access to one or more online vendors 106. In certain embodiments, a collection server 108 is also provided to connect to the electronic device through the internet.

The electronic device 102 can be any type of suitable personal electronic device capable of being configured to perform the functionality of the present invention. The electronic device 102 is merely an illustrative example of a suitable computing environment and in no way limits the scope of the present invention. An “electronic device,” as represented by FIG. 1, can include a “workstation,” a “server,” a “laptop,” a “desktop,” a “hand-held device,” a “mobile device,” a “tablet computer,” or other computing devices, as would be understood by those of skill in the art. Given that the electronic device 102 is depicted for illustrative purposes, embodiments of the present invention may utilize any number of electronic devices 102 in any number of different ways to implement a single embodiment of the present invention. Accordingly, embodiments of the present invention are not limited to a single electronic device 102, as would be appreciated by one with skill in the art, nor are they limited to a single type of implementation or configuration of the example electronic device 102. The electronic device 102 will be discussed in more detail later in this description.

The internet 104 or similar cloud or other network provides the network connectivity between the various components 102, 106, 108 of the system, allowing the components to communicate with each other. For example, the internet 104 allows the electronic device 102 to access the storefronts of the online vendors 106 in carrying out electronic commerce of the present invention. While, in this example the internet is provided as the network connectivity between the components 102, 106, 108 of the system, it will be understood by ones skilled in the art that other types of networks or connectivity can be used.

The online vendors 106 are entities that offer items for purchase online or otherwise over the internet. The online vendors 106 provide the logistic for the purchasing and delivery of goods to a user. An example of an online vendor 106 is Amazon.com®. In other embodiments, the online vendor can be a vendor local in physical proximity to the location of the user.

In certain embodiments, a collection server 108 is provided. The collection server maintains 108 a catalog identifying item in use at various locations that can serve as physical representations of items available for sale from the online, such as from an online vendor 106. The use of such a catalog is described in more detail later in this description.

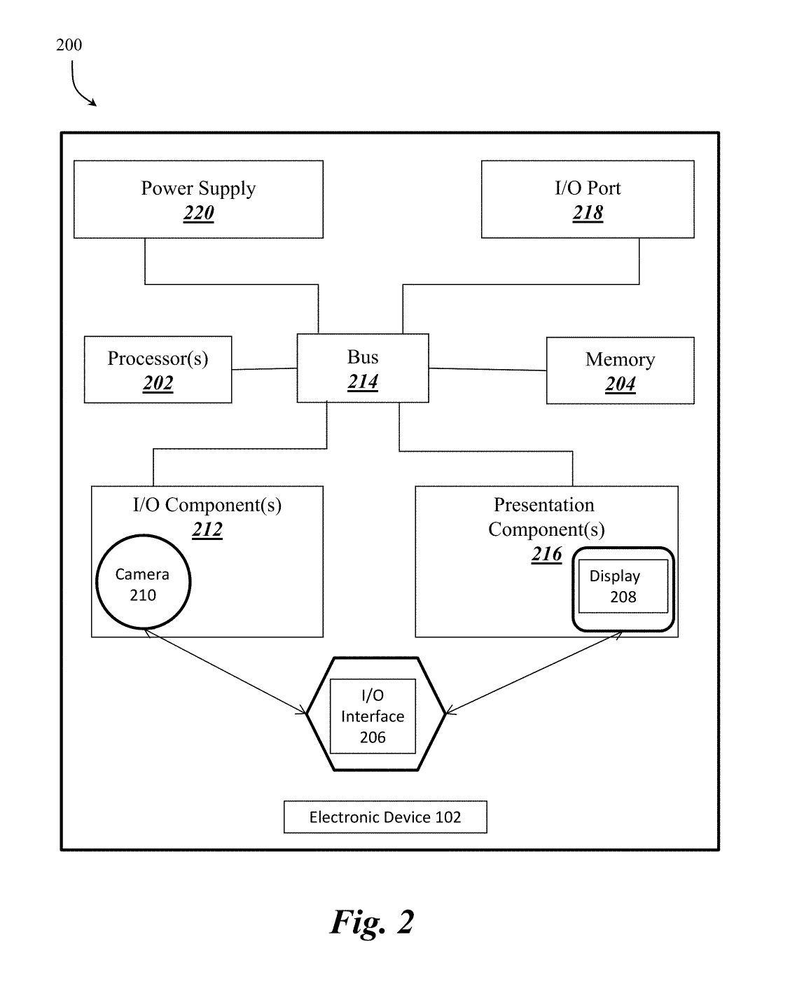

FIG. 2 provides an example schematic depiction 200 of the components of the electronic device 102 of FIG. 1. In this example, the electronic device 102 includes a bus 214 coupled to one or more of the following illustrative components, directly or indirectly, including: one or more processors 202, memory 204, an Input/Output interface 206, input/output components 212 comprising an optical input device or sensor comprising a camera 210, one or more presentation components 216 comprising a display 208, input/output ports 218, and a power supply 220. One of skill in the art will appreciate that the bus 214 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 2 is merely illustrative of an example computing device that can be used to implement one or more embodiments of the present invention, and in no way limits the invention.

The one or more processors 202 can be any processor or processors capable of performing the functionality and methodology of the present invention. The one or more processors 202 can be single or multi-core. Examples of suitable processors include, but are not limited to, processors produced by Intel, AMD, Apple, and Samsung. The electronic device 102 can include one or more processors 202 that read data from components such as the memory 204, the various I/O components 212, etc.

The electronic device 102 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the electronic device 102. The memory 204 can include computer-storage media in the form of volatile and/or nonvolatile memory. The memory 204 may be removable, non-removable, or any combination thereof. Example hardware devices are devices such as hard drives, solid-state memory, optical-disc drives, and the like.

The input/Output (I/O) interface 206 enables the one or more processors 202 to input and output data. For example, the I/O interface 206 can connect the one or more processors 202 to the display 208 and camera 210 of the electronic device 102 depicted in FIG. 2.

Presentation component(s) 216 present data indications to a user or other device. Example presentation components include a display device 208, speaker, printing component, vibrating component, etc. The example display 208 of the electronic device 102 is an electronic display such as a Liquid Crystal Display (LCD) or Organic Light Emitting Diode (OLED) display capable of displaying data from the electronic device 102.

The I/O ports 218 can enable the electronic device 102 to be logically coupled to other devices, such as I/O components 212. Some of the I/O components 212 can be built into the electronic device 102. Examples of such I/O components 212 include a microphone, joystick, recording device, game pad, satellite dish, scanner, printer, wireless device, networking device, and the like. In certain embodiments, the electronic device may also include an optical input device or sensor, such as a camera 210. In other embodiments, the optical device can be an optical scanner such as a barcode or Quick Response (QR) code scanner.

One of skill in the art additionally will appreciate that, depending on the intended applications and uses of a particular embodiment, multiple of these components can be implemented by a single device. Similarly, in some instances, a single component can be implemented by multiple devices. As such, FIG. 2 is merely illustrative of an example computing device that can be used to implement one or more embodiments of the present invention, and in no way limits the invention.

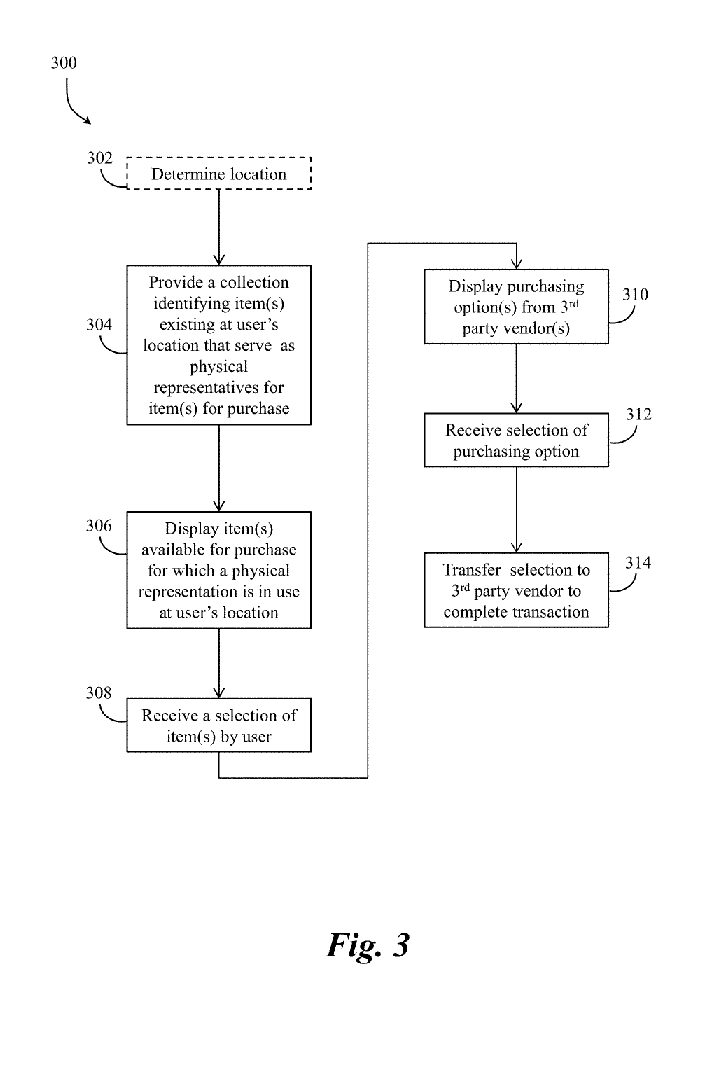

In certain embodiments, the provided electronic device 102 of FIG. 1 and FIG. 2 configured to perform the methodology of the present invention. An example of the methodology can be seen in FIG. 3.

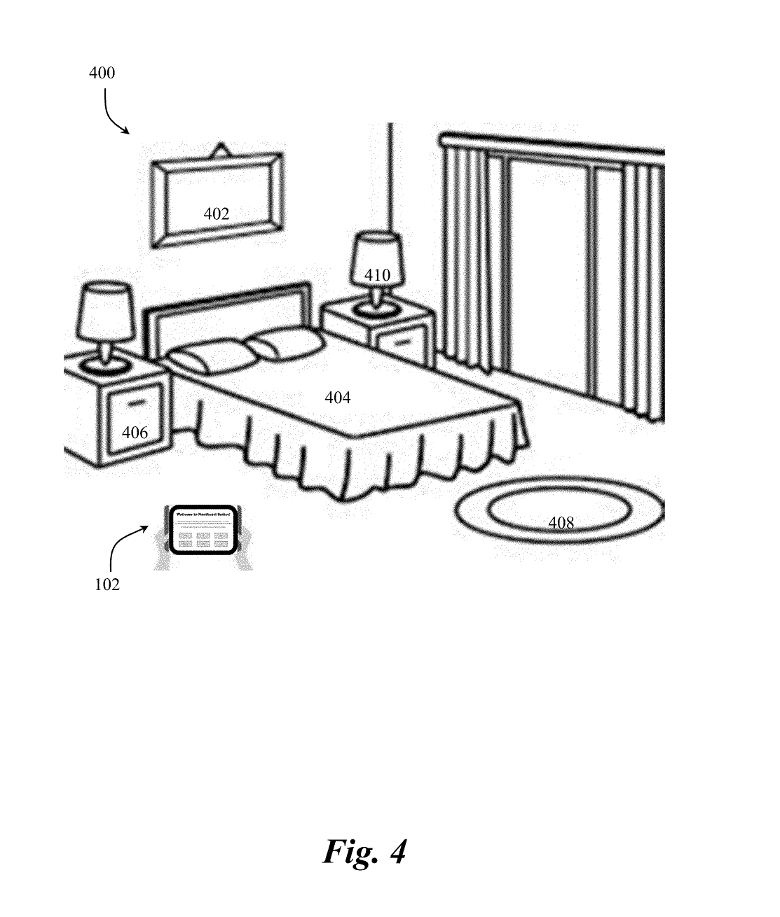

FIG. 3 depicts a flow diagram 300 of the methodology performed by the electronic device in accordance with an embodiment. In operation, the electronic device 102 performs the step of: providing a collection identifying one or more items existing at the user location that serve as representative physical items in use for one or more items available for purchase 304; displaying one or more items available for purchase for which a representative physical item in use exists at the user location 306; receiving a selection by the user of the one or more items available for sale for which a representative physical item in use exists at the user location 308; displaying one or more purchasing options from one or more third party vendors for the one or more items selected by the user 310; receiving a selection of one or more purchasing options from a user 312; and transferring the user's item selection to the one or more third party vendor providing the one or more purchasing options selected by the user to complete a purchase transaction for the one or more items selected by the user. In certain embodiments, the electronic device 102 also determines the location of the user 302. Each of these step will be discussed in more detail below in reference to FIGS. 4-FIG. 8.

One key feature of the present invention is its locational awareness. That is, the user location factors into determining what items in use at the location can be used as physical representations for items available for purchase online. As such, in certain embodiments, the methodology 300 of FIG. 3 includes the step of determining the location of the user 302. The location of the user can be determined using the inherent functionality of the electronic device 102. For example, GPS location services on the electronic device 102 can be used. Alternately, the Wi-Fi or other network connectivity can be used to determine the user's location. For example, connecting to a network provided at the location indicates that the electronic device 102 (and the user) is at that location. Other technologies such as RFID or NFC can also be used to indicate location.

In an example embodiment, the user can indicate his or her location directly on the electronic device 102. For example, a user could “check in” at a location using the electronic device 102. In still other embodiments, the electronic device 102 could be tethered either physically or electronically to a specific location, such that the functionality of the present invention only works for the location the device is tethered to. Multi-factor authentication processes can also be incorporated into the confirmation of the user and their authority to make purchases (e.g., a combination of user login, room information, device information, geophysical location, time of day (e.g., when the user is deemed to be renting the space), and the like, as would be appreciated by those of skill in the art.

FIG. 4 depicts an example physical location 400 in which the functionality of the present invention can operate. In this example, the electronic device 102 (and the user using it) is located in lodging, such as a hotel room 400. The hotel room 400 is provided with amenities and furnishing such as art 402, mattresses 404, furniture 406, rugs 408, lamps 410, and Televisions (not shown) which are in use in the hotel room 400. In accordance with embodiments of the present invention, any or all of these amenities or furnishing can serve as physical representations of items available for sale or purchase online. As stated above, hotels, inns, bed and breakfasts, and other lodgings, as well long and short term rental properties make for ideal locations for the functionality of the present invention. The location of hotels or other lodgings are typically fairly well established, and the amenities and furnishings provided are often cataloged for insurance and loss prevention purposes, thus reducing the logistical and technological issues of identifying the existing items in use at the location. However, it should be understood that the functionality of the present invention is no way limited to hospitality or rental locations. Any number and types of locations can be used. Suitable locations will be apparent to one skilled in the art given the benefit of this disclosure.

Having established the location of the user (step 302), a catalog is provided to identify items in use at the location that can serve physical representation of items available for purchase (step 304). The catalog is a registry or listing indicating items in use at a location which can serve as physical representations of items available for purchase. The catalog can be updated as items in use at a location change or items available for purchase change. In certain embodiments, the catalog is maintained on the electronic device 102 as part of the software providing the functionality of the present invention on the electronic device 102. In other embodiments, the catalog may be maintained on a server, such as the collection server 106 of FIG. 1 and downloaded to the electronic device 102 as needed to identify items at a location that can serve as physical representations for items available for purchase. The catalog can be updated or otherwise maintained by the provider of the functionality of the present invention, an online vendor 106 providing the items for sale, the proprietor or owner of the location, the owner or provider of the item in use, or any combination thereof. The catalog can also be used to determine what party provided for the location, physical item, and/or item for sale which can be used in determining commissions or other compensations for a resulting purchase.

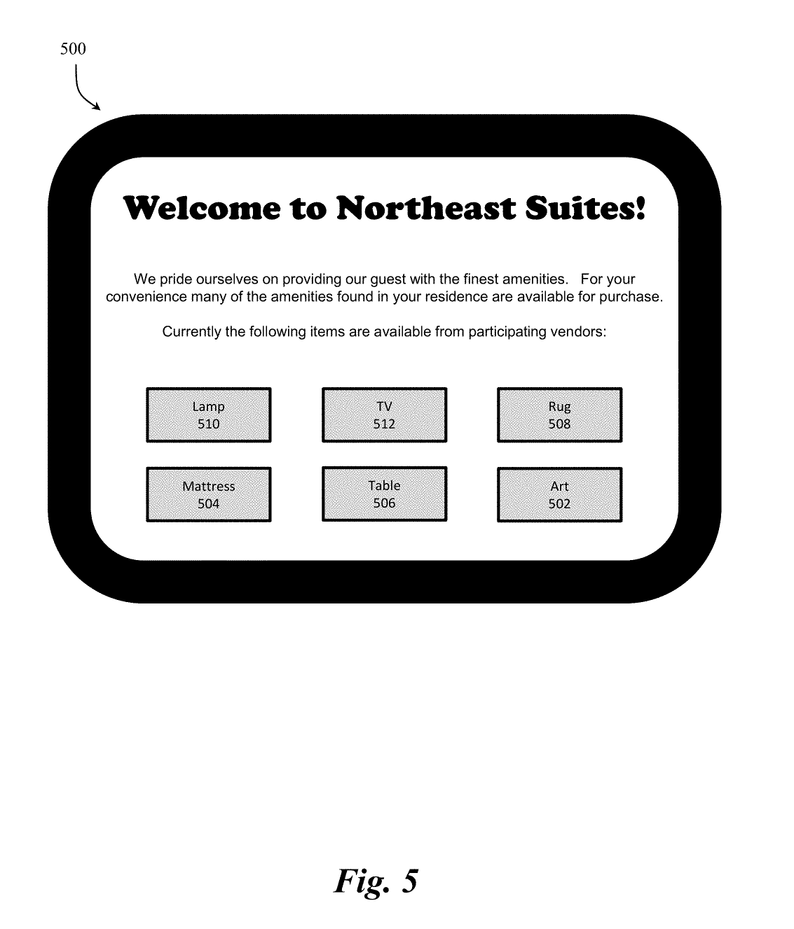

Once items in use at the location that can function as a physical representation are identified (step 304), the items available for purchase for which there are physical representations in use are displayed to the user (step 306). An example of this can be seen in FIG. 5.

FIG. 5 is an example screenshot 500 provided on a display 208 of the electronic device 102 displaying one or more items available for sale for which there is a physical representation in use at the user's location. Thus for the example of FIG. 4, where the user is in a hotel room 400, the screenshot 500 displays that there is art 502, a mattress 504, table 506, rug 508, lamp 510 and television 512 available for purchase for which there are physical representations in use in the hotel room 400. Thus, a user can view, use, evaluate, or otherwise interact with any of the art 402, mattress 404, table 406, rug 408, lamp 410, and Television (not shown) provided in the hotel room 400 to help determine if they wish to purchase any items 502-512 available for purchase.

In certain embodiment, the display of items available for purchase may be curated. For example certain vendors and/or products may be given preference in the display while other vendors and/or products may be omitted from the display entirely. For example, a preference for local vendors and/or products could be implemented. Other possible preferences, rules or policies for the display of item available for purchase will be apparent to one skilled in the art given the benefit of this disclosure.

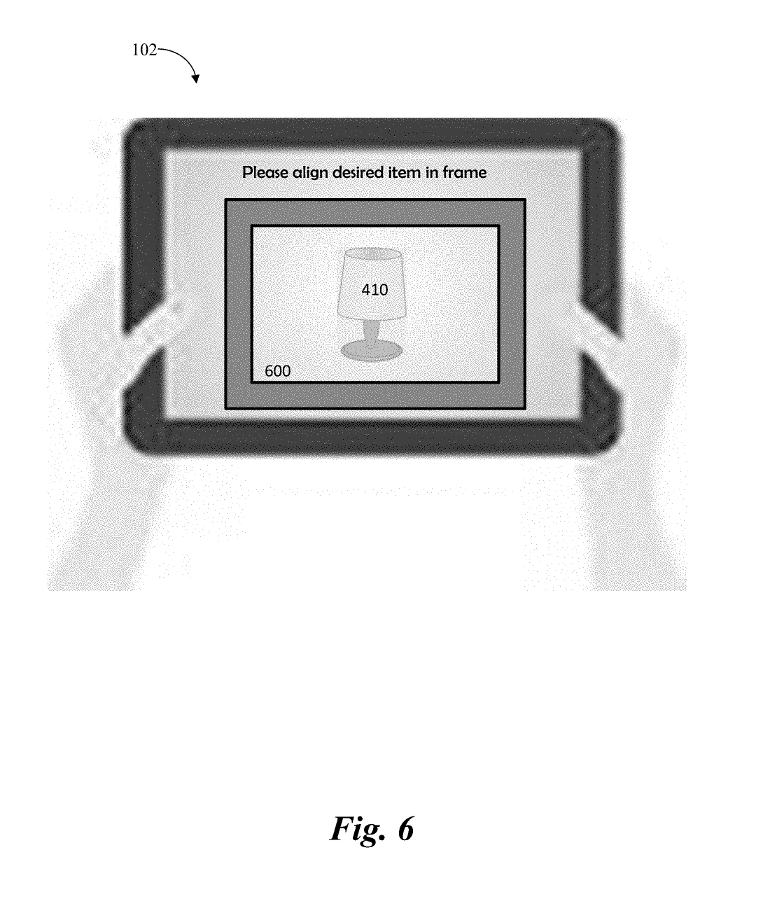

If a user decides to purchase a displayed item available for purchase, the selections of the item can be made on the electronic device 102 (step 308). In certain embodiment the selection is made using an input mechanism on the electronic device 102, such as a touch screen, keyboard, mouse, or touchpad. In other embodiments, an optical device can be used to make a selection. An example of this can be seen in FIG. 6.

In the depiction of FIG. 6, the camera 210 of the electronic device 102 is used to select the item. In this example, the user uses the camera 210 to select the lamp 510 available for purchase by locating the physical representation of the lamp 410 in a frame 600 provided on the display 208 of electronic device 102. In other embodiments, alternate optical devices may be used to make a selection. For example, an optical scanner can be used to scan QR or Bar codes attached to the physical items 402-410 in the room. Other possible implementations or configuration for such optical selection will be apparent to one skilled in the art given the benefit of this disclosure.

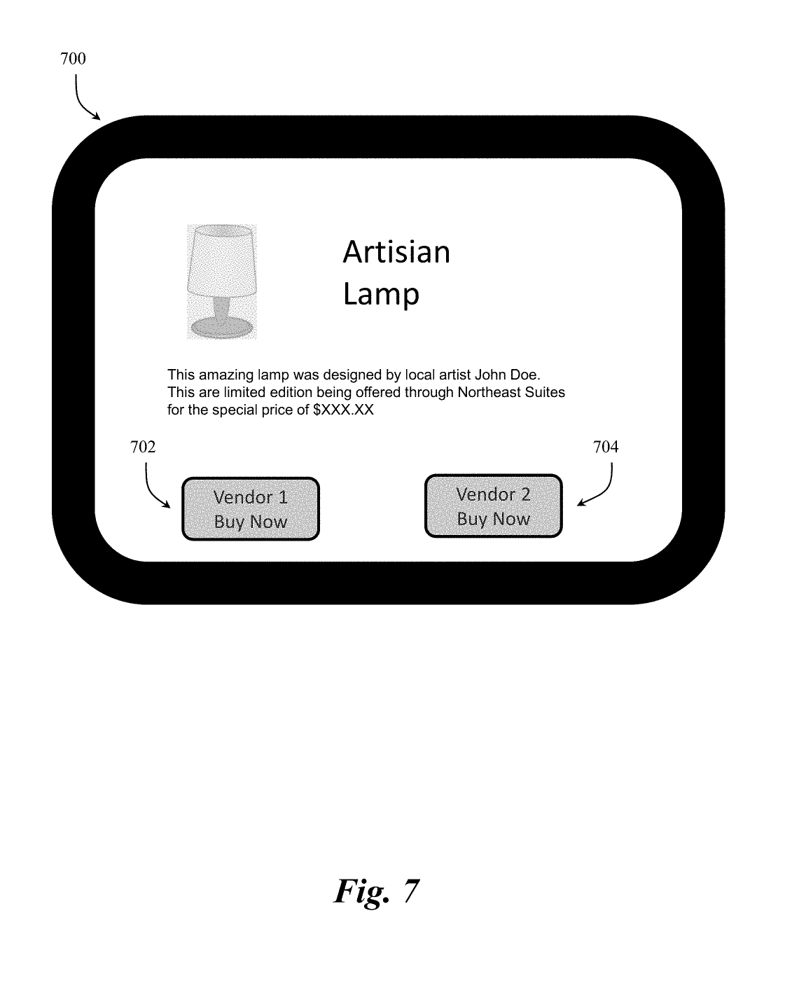

Once the selection is received (step 308), purchasing options for the selected item are displayed to the user (step 310). An example of this can be seen in FIG. 7.

FIG. 7 is an example screenshot 700 provided on a display 208 of the electronic device 102 displaying one or more purchasing options from one or more third party vendors for the item selected by the user. In this embodiment, the user is given the option of purchasing the selected item from either a first vendor 702 or a second vendor 704.

In certain embodiment, the display of purchasing options from vendors may be curated. For example certain vendors and/or purchasing options may be given preference in the display while other vendors and/or purchasing options may be omitted from the display entirely. For example, a preference for local vendors could be implemented. Other possible preferences, rules or policies for the display of item available for purchase will be apparent to one skilled in the art given the benefit of this disclosure.

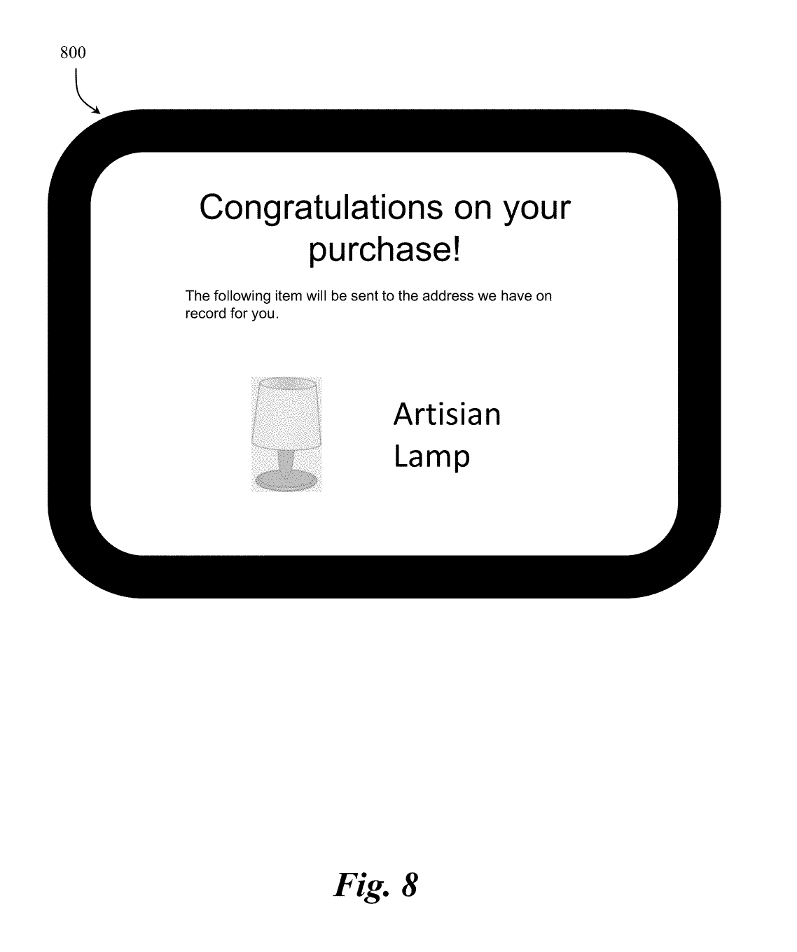

If a user decides to on a purchasing option, the selections of the can be made on the electronic device 102 (step 312). In certain embodiment the selection is made using an input mechanism on the electronic device 102, such as a touch screen, keyboard, mouse, or touchpad. The selection is then transferred to the indicated third party vendor so the transaction can be completed (step 314). In certain embodiments, in addition to the item and purchasing option selected, the user's purchasing data may also be transferred to the third party. Examples of such purchasing data transferred can include the users' shipping address, the user's billing address, the user's credit card data, and the like. In certain further embodiments, a confirmation of the transaction can be displayed to the user. An example of this can be seen in FIG. 8.

FIG. 8 is an example screenshot 800 provided on a display 208 of the electronic device 102 displaying a confirmation of the transaction. In this embodiment, the user is informed the item has been purchased and being shipped to the user. One or more items existing at the user's location can serve as representative physical items are subsidized, at least in part, by the one or more third party vendors offering the item for purchase. The proprietor of the user's location can be compensated for use of the location in the purchase transaction of the one or more items for hosting the one or more items existing at the location that serve as representative physical items in use for one or more items available for purchase.

Thus, the methods and devices providing the functionality of the present invention allow the items in use at the user's location to act as physical representations of items available for purchase electronically. Thus, the user's location becomes, in effect, a showroom for items available for purchase online for which the same or similar corresponding physical representations exist and are in use at the user's location. Having access the physical representations of the items before the purchase of the item allows the user to interact and evaluate the item leading to a more informed purchasing decision and less buyer's remorse. Furthermore, since the location and physical items in use at the location are identified as part of the purchasing transaction provided by the present invention, additional financial possibilities become available. For example, the items provided at location for use as physical representation of items available for purchase could be provided or otherwise subsidized by a vendor hoping to sell the particular item. Thus, the vendor gets access to free or minimal cost showroom while the owner or proprietor of the location gets free or minimal cost amenities and/or furnishings for the location. Alternately, the owner or proprietor of the location could be compensated for the use of the location as a showroom. For example, the owner or proprietor could receive a commission or percentage for transactions initiated from the location for hosting the physical representation of the item that was purchased.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for purchasing items for which representative physical items are in use at a user location, the method comprising:
providing, on an electronic device using a processor, a collection identifying one or more items existing at the user location that serve as representative physical items in use for one or more items available for purchase;
displaying, on the electronic device using a graphical user interface, one or more items available for purchase for which a representative physical item in use exists at the user location;
receiving, using a user interface of the electronic device, a user item selection by the user of the one or more items available for sale for which a representative physical item in use exists at the user location;
displaying, on the electronic device using the graphical user interface, one or more purchasing options from one or more third party vendors for the one or more items selected by the user;
receiving, using a user interface of the electronic device, a selection of one or more purchasing options from a user; and
transferring, from the electronic device using the processor and an electronic network, the user item selection to the one or more third party vendors providing the one or more purchasing options selected by the user to complete a purchase transaction for the one or more items selected by the user.

2. The method of claim 1, further comprising providing an electronic device, the electronic device comprising;
a memory for storing data including a collection identifying one or more items existing at the user location that serve as representative physical items in use for one or more items available for purchase; and
an electronic display for displaying data.

3. The method of claim 1, wherein the user location comprises a rental property.

4. The method of claim 1, wherein the one or more third party vendors comprises a local vendor.

5. The method of claim 1, wherein the one or more items for purchase comprise a domestically manufactured product.

6. The method of claim 1, further comprising determining, on the electronic device, the location of a user.

7. The method of claim 1, wherein providing a collection identifying one or more items existing at the user location that serve as representative physical items in use for one or more items available for purchase comprises obtaining the collection from a server.

8. The method of claim 1, wherein the selection of an item available for purchase is made via a provided optical input device or sensor, and displaying, on the electronic device using the graphical user interface, one or more purchasing options from one or more third party vendors for the one or more items selected by the user further comprises:
receiving, using a provided optical input device or sensor, a processor comprising an image recognition tool, item data that includes comprising one or more images for each of one or more items;
capturing and extracting embedded data within the one or more images or the one or more items through using the image recognition tool;
compiling a list of identity attribute data for the one or more items from the embedded data captured and extracted from of the one or more images by the image recognition tool;
comparing the list of identity attribute data to the collection identifying one or more items existing at the user location previously received from participating third party vendors and stored in a data store;
mapping, using an algorithm comprising matching rules and the processor, the item selection by the user to the one or more items available for sale saved in the data store as part of the collection identifying one or more items existing at the user location and the one or more third party vendors corresponding to the one or more items available that were mapped, based on compared identity attribute data from the list of identity attribute data and stored attributes of the collection identifying one or more items existing at the user location; and
recording in the data store, and providing to the electronic device for display on the graphical user interface, product data comprising the one or more items available for sale mapped to the user item selection by the user and navigation data for one or more purchasing options comprising one or more links.

9. The method of claim 1, wherein one or more items existing at the user location that serve as representative physical items are subsidized, at least in part, by the one or more third party vendors offering the item for purchase.

10. The method of claim 1, wherein the proprietor of the user location is compensated for use of the location in the purchase transaction of the one or more items for hosting the one or more items existing at the location that serve as representative physical items in use for one or more items available for purchase.

11. The method of claim 1, wherein transferring, from the electronic device, the user item selection to the one or more third party vendors providing the one or more purchasing options selected by the user to complete a purchase transaction for the one or more items selected by the user further comprises transferring user purchasing data along with the selection to one or more websites or web portals provided by the one or more third party vendors.

12. The method of claim 1, wherein the data store comprises a database accessible to the electronic device, wherein the product data further comprises item attribute data, and the one or more third party vendors providing the one or more purchasing options corresponding to the one or more items available for sale identified, and wherein the navigation data for the one or more purchasing options further comprises one or more links comprising an universal resource locator (URL) or web address of the one or more third party vendors identified by the electronic device to be used to complete a purchase transaction.

13. An electronic device for facilitating purchasing items for which representative physical items are in use at a user location, the electronic device comprising:
a memory for storing data and instructions for execution; and
a processor configured to:
provide a collection identifying one or more items existing at the user location that serve as representative physical items in use for one or more items available for purchase;
display one or more items available for purchase for which a representative physical item in use exists at the user location;
receive a user item selection by the user of the one or more items available for sale for which a representative physical item in use exists at the user location;
display one or more purchasing options from one or more third party vendors for the one or more items selected by the user;
receive a selection of one or more purchasing options from a user;
transfer the user item selection to the one or more third party vendors providing the one or more purchasing options selected by the user to complete a purchase transaction for the one or more items selected by the user; and
an electronic display comprising a graphical user interface for displaying data on the electronic device.

14. The electronic device of claim 13, wherein the electronic device configured to display one or more purchasing options from one or more third party vendors for the one or more items selected by the user further comprises:
receiving, using a provided optical input device or sensor, a processor comprising an image recognition tool, item data that includes comprising one or more images for each of one or more items;
capturing and extracting embedded data within the one or more images or the one or more items through using the image recognition tool;
compiling a list of identity attribute data for the one or more items from the embedded data captured and extracted from of the one or more images by the image recognition tool;
comparing the list of identity attribute data to the collection identifying one or more items existing at the user location previously received from participating third party vendors and stored in a data store;
mapping, using an algorithm comprising matching rules and the processor, the item selection by the user to the one or more items available for sale saved in the data store as part of the collection identifying one or more items existing at the user location and the one or more third party vendors corresponding to the one or more items available that were mapped, based on compared identity attribute data from the list of identity attribute data and stored attributes of the collection identifying one or more items existing at the user location; and
recording in the data store, and providing to the electronic device for display on the graphical user interface, product data comprising the one or more items available for sale mapped to the user item selection by the user and navigation data for one or more purchasing options comprising one or more links.

15. The electronic device of claim 13, wherein the electronic device comprises a personal electronic device.

16. The electronic device of claim 13, wherein the user location comprises a rental property.

17. The electronic device of claim 13, wherein the one or more third party vendors comprises a local vendor.

18. The electronic device of claim 13, wherein the one or more items for purchase comprise a domestically manufactured product.

19. The electronic device of claim 13, wherein the processor is further configured to: determine the location of a user.

20. The electronic device of claim 13, wherein the provided collection identifying one or more items existing at the user location that serve as representative physical items in use for one or more items available for purchase is obtained from a server.

21. The electronic device of claim 13, further comprising an optical device, wherein the selection of an item available for purchase is made using the optical input device.

22. The electronic device of claim 13, wherein one or more items existing at the user location that serve as representative physical items are subsidized, at least in part, by the one or more third party vendors offering the item for purchase.

23. The electronic device of claim 13, wherein the proprietor of the user location is compensated for use of the location in the purchase transaction of the one or more items for hosting the one or more items existing at the location that serve as representative physical items in use for one or more items available for purchase.

24. The electronic device of claim 13, wherein the transfer of the user item selection to the one or more third party vendors providing the one or more purchasing options selected by the user to complete a purchase transaction for the one or more items selected by the user further comprising transferring user purchasing data along with the selection.

25. The electronic device of claim 13, wherein the data store comprises a database accessible to the electronic device, wherein the product data further comprises item attribute data, and the one or more third party vendors providing the one or more purchasing options corresponding to the one or more items available for sale identified, and wherein the navigation data for the one or more purchasing options further comprises one or more links comprising an universal resource locator (URL) or web address of the one or more third party vendors identified by the electronic device to be used to complete a purchase transaction.
